(19) United States
(12) Patent Application Publication
(10) Pub. No.: US 2015/0330787 A1
(43) Pub. Date: Nov. 19, 2015

(54) Systems, Methods and Software for Redirecting Blind Travelers Using Dynamic Wayfinding Orientation and Wayfinding Data

(71) Applicants: Joseph CIOFFI, Minneapolis, MN (US); William CRANDALL, Sausalito, CA (US)

(72) Inventors: Joseph CIOFFI, Minneapolis, MN (US); William CRANDALL, Sausalito, CA (US)

(21) Appl. No.: 14/705,375

(22) Filed: May 6, 2015

Related U.S. Application Data
(60) Provisional application No. 62/000,040, filed on May 19, 2014.

(51) Int. Cl. G01C 21/00; G06Q 30/02

(52) U.S. Cl. CPC G01C 21/00; G06Q 30/0261; G06Q 30/0267

(57) ABSTRACT

A wayfinding system includes a server configured to deliver navigational information associated with a route to user devices which output the navigational information to blind or low vision users in their preferred output format. That navigation information can be augmented by additional navigation information that is delivered in real time to the blind or low vision users as a result of receiving signals from proximity beacons associated with the wayfinding system.

### RELATED APPLICATIONS

The present application is related to U.S. Pat. No. 8,594,935, to Cioffi et al, hereafter the “'935 patent”, the disclosure of which is incorporated here by reference. The present application is also related to, and claims priority from, U.S. Provisional Patent Application No. 62/000,040, filed May 19, 2014, the disclosure of which is incorporated here by reference.

### COPYRIGHT NOTICE AND LIMITED PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### TECHNICAL FIELD

Various embodiments of the present invention concern systems and methods for providing wayfinding information to blind and/or visually impaired pedestrians.

### BACKGROUND

Effective mobility depends upon proper orientation; for the non-disabled public this is accomplished by printed signs that provide general information, identification and directions. In the broadest sense, signs comprise a menu of choices; they present travelers with the options available at any given point in their environment. In addition, signage acts as a form of memory for travelers, reminding them about important characteristics of the environment. Any effective wayfinding strategy for visually impaired individuals must therefore implicitly compensate for this missing information by promoting the formation of mental models of the environment, which mental models are sometimes referred to as cognitive maps. To be rich and useful, cognitive maps need to be formed by the interplay of various levels of detail about the environment.

Wayfinding is a type of spatial problem solving where the goal is to reach a destination. It consists of three interrelated processes: decision making and development of a plan of action, decision execution at the right place in space and information processing comprising environmental perception and cognition. The complex activity of wayfinding may be thought of as a chain of tasks involving things, places and actions that must take place in a specific order. And, like any chain, it is only as strong as the weakest link; any broken link can significantly delay the trip (or result in a failure to reach destination). The frustration brought about by these delays and the effort needed to locate the proper information may be sufficient to prevent the traveler from attempting this trip again. For an unfamiliar trip, the trip must first be planned, including routes and schedules.

Blind pedestrians use a variety of travel aids. Chief among these are white canes and guide dogs. However, recent years have seen the emergence of navigational aid systems based on newer location based technologies. These location based technologies or services can be divided into two major groups; those that compute the location and movement of assets or people in real-time and those that label objects or places. In the former case, the traveler would be guided to the goal location by comparing the known location of the traveler to the known location of the goal (e.g., WiFi triangulation, dead reckoning, magnetic (‘signature’) positioning, GPS, artificial vision, virtual sighted guides) or in the latter case, the traveler would inspect the environment to determine the appropriate direction of travel using various technologies and non-visual cues (e.g., infrared beacons, audible beacons, Bluetooth beacons, RFID beacons, smells, sounds, and tactile and proprioceptive cues). Some technologies, such as magnetic (‘signature’) positioning, that promise a high degree of position accuracy are presently undergoing development. Others, like Infrared (Remote Infrared Audible Signage) have a significant body of validating research, a comparatively large build-out, and have been demonstrated to be successful in satisfying a wide range of wayfinding challenges.

Although these high-tech systems provide some benefits, e.g., by more or less accurately identifying discrete locations, the present inventors have recognized that they suffer from disadvantages that have prevented widespread adoption. Most blindness wayfinding systems have failed to achieve commercial success for several reasons: 1) they require that properties/facilities purchase, install and maintain expensive technology, 2) the users, themselves, may be required to purchase end user hardware, and 3) users must obtain and master a new and often complex interface. Additionally, the street-based routing information provided by some of these systems is set up for users with normal vision and therefore of minimal to no value to blind and visually impaired travelers.

Wayfinding is needed for both outdoor and indoor routes, as well as routes that have both outdoor and indoor components. Indoor routes, e.g., subway systems, present additional challenges because, for example, some technologies like GPS are not available or work poorly indoors. Thus another drawback of existing wayfinding techniques and systems is their inability to seamlessly bridge indoor and outdoor environments.

Accordingly, the present inventors have recognized a need for better ways of providing wayfinding information to blind and visually impaired pedestrians. For example, as described among other things in the above-incorporated by reference '935 patent, to support the independence and mobility of blind pedestrians, the present inventor devised, among other things, systems, methods, and software for providing narrative blind-ready wayfinding information. One exemplary system receives user input identifying a starting landmark and ending landmark in a particular selected geographic region, such as a city, university campus, government building, shopping mall, or airport. The system then searches a database for the corresponding narrative wayfinding instructions, and outputs them in the form of text or audio to guide a blind pedestrian from the starting landmark to the ending landmark. In the exemplary system, blind users select the geographic region as well as the starting and ending landmark from a voice-driven telephonic menu system and receive audible wayfinding instruction via mobile telephone.

While the embodiments described in the '935 patent provide an excellent starting point for enabling blind and/or vision impaired individuals to navigate, e.g., complicated, urban landscapes, such embodiments can be improved upon. For example, it would be desirable to provide techniques and systems for redirecting such individuals who, having been provided with wayfinding information, e.g., as described in the '935 patent, nonetheless become lost or stray from the path toward their geographical point of interest.

### SUMMARY

According to an embodiment, a method for aiding a blind or low vision traveler to navigate through a predetermined area includes the step of providing, from a user access device carried by the blind or low vision traveler, a set of baseline navigation instructions for traversing the predetermined area. Then, the user access device carried by the blind or low vision traveler, outputs additional navigational guidance information when the blind or low vision traveler is close enough to a proximity beacon to receive its signal.

According to another embodiment, a user device for assisting a blind or low vision user to navigate a predetermined area includes a processor configured to execute a blind or low vision navigation application which outputs a set of baseline navigation instructions for traversing the predetermined area. The user device also includes a receiver configured to receive a signal from a proximity beacon disposed in the predetermined area and to output additional navigational guidance information when the blind or low vision traveler is close enough to the proximity beacon to receive its signal.

According to still another embodiment, a wayfinding system includes a server configured to deliver navigational information associated with a route to a plurality of user devices. The plurality of user devices are configured to receive the navigational information and to output the navigational information to blind or low vision users in their preferred output format. The system also includes a plurality of proximity beacons disposed along said route and configured to periodically transmit advertisement messages including at least one identification code which identifies them as part of the wayfinding system.

### BRIEF DESCRIPTION OF THE DRAWINGS

FIG. 1 is a block diagram of an exemplary blind pedestrian wayfinding system corresponding to one or more embodiments of the present invention.

FIG. 2 is a flow chart of an exemplary method of operating a blind pedestrian wayfinding system, corresponding to one or more embodiments of the present invention.

FIG. 3 is a facsimile of an exemplary graphical user interface 300, which corresponds to one or more embodiments of the present invention.

FIG. 4 is a facsimile of an exemplary graphical user interface 400, which corresponds to one or more embodiments of the present invention.

FIGS. 5A-5C depict various applications of proximity beacons to wayfinding systems according to embodiments.

FIG. 6 illustrates a data packet format for an i-beacon message.

FIGS. 7A and 7B depict an airport wayfinding scenario and an exemplary user interface screen according to an embodiment.

### DETAILED DESCRIPTION

This document, which incorporates the drawings and the appended claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular feature, structures, or characteristics may be combined in any suitable manner in one or more embodiments.

### Exemplary Blind Wayfinding Data System

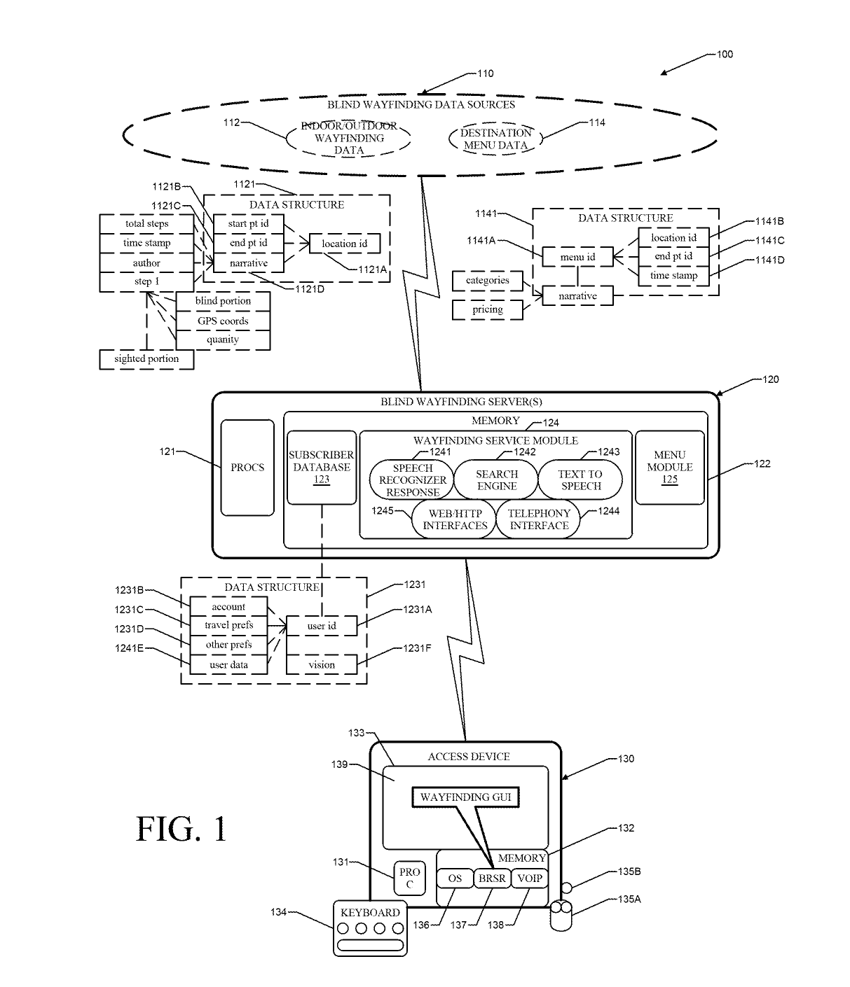

FIG. 1 shows an exemplary blind wayfinding data system 100. System 100 includes blind wayfinding databases 110, a blind wayfinding data servers 120, and access devices 130.

### Exemplary Blind Wayfinding Data Sources

Blind wayfinding data sources 110 include an indoor-outdoor blind wayfinding database 112, and a destination menu database 114. Indoor-outdoor blind wayfinding database 112 includes indoor-outdoor blind wayfinding route data in the form of narrative walking routes between two outdoor points or landmarks (such as intersections, buildings, facilities) or between two indoor points or facility features, such as entry doors, offices, elevators, restrooms. In some embodiments, routes can encompass both indoor and outdoor landmarks and features. Database 112, which for example takes the form of a SQL database, includes one or more narrative maps.

In the exemplary embodiment, each narrative map takes the form of a set of one or more textual and/or audio instructions, and is prepared by mobility specialists incorporating terminology, technique recommendations, and landmarking cues that work for blind travelers. An exemplary 6-step narrative map is provided below.

### Route: Coffman Memorial Hall to Moos Tower:

1. Exit main front doors of Coffman Memorial Hall. You are facing North in the direction of Washington Ave. This is a 10-foot wide pathway with grass edges on both left and right sides as you walk in a perpendicular direction towards Washington Ave. Proceed straight until you reach the Washington Ave sidewalk in 30 feet.

2. Turn right at this intersecting sidewalk, now facing East on Washington Ave. Continue straight and in 50 feet you will reach the first down curb at the T-intersection of Church and Washington.

3. This is a light controlled T-intersection with 2-way traffic. Cross straight and continue along Washington Ave.

4. At mid-block, while following the right side edge of this sidewalk (there is a curb guideline along this right edge), the sidewalk increases significantly in width, from 10 feet to 30 feet. This is at the 200-foot marker of this block.

5. Walk straight for another 20 feet and make a right turn, now facing South. Continue straight until you reach ascending stairs. Take these 10 steps to the top landing, and walk straight 20 feet until you find the perpendicular wall of a building.

6. This is Moos Tower. Turn left and here and trail until you feel the double door entrance in 20 feet.

Narrative map data, like the exemplary 6-step narrative map provided above, is stored in, for example, tables in a relational database, which are generally representative of narrative map data structures, of which data structure 1121 is generally representative. Data structure 1121 includes a location identifier 1121A, a starting point identifier 1121B, an end or destination point identifier 1121C, and narrative text instructions 1121D. Location identifier 1121A uniquely identifies a geographic region or facility, such as University of Minnesota, which is associated with starting point identifier 1121B and ending point identifiers 1121C. (It is assumed in the exemplary embodiment that pedestrians will be traveling within a single location or region; however, other embodiments may provide for starting points and ending points that are in separate zones by, for example, allowing a starting or ending point to be associated with more than one location identifier.) Narrative text instructions 1121D is itself logically associated with a total steps indicator for indicating the number of steps in the instructional sequence, a time stamp indicator for indicating the last time the narrative instructions were updated, an author indicator for indicating the author(s) of the narrative instruction, as well as one or more narrative step instructions, such as step 1. Portions of each instructions are further associated with tags or corresponding fields to identify portions of instructions that are intended to support blind pedestrians.

Additionally, one or more portions of each step instruction are associated with GPS coordinates to facilitate use of other data and functions that may be correlated to such coordinates. For example, this allows synchronized output of the instruction as text, Braille, or audio based on real-time measured or estimated position of the user. However, other embodiments allow the user to advance, pause, or backup to replay presentation of a narrative map using a voice or manually input command.

Some embodiments support GPS interfacing. This enables users having mobile phones or other devices with GPS or analogous capability to user such GPS data as an input to the wayfinding system. For example, if a user is positioned at a landmark correlated to current positional coordinates, the system can receive a generic command such as “from here, how do I get to the library,” and have the system be able to correlate based on GPS or cell phone tower location data or Wifi location data to the appropriate set of directions, with appropriate user confirmation input or preference data to resolve any ambiguities. In some instances, the positional data can be used to negate or defeat presentation of certain menu options.

The narrative maps can be conveyed over the network in any desired data format, e.g., text. In some embodiments, the narrative maps are converted by a multimedia encoding system into multimedia files using encoding servers as part of the textual data entry process for the narrative maps. The encoding system creates multi-media files of the step-by-step directions and other location information using codecs for MPEG (mp3), Adobe Flash (fly), Microsoft Windows Media (wmv), and/or Apple Quicktime (mov).

Destination menu database 114 stores one or more textual restaurant (or more generally government or business service) menus. The menus are stored in the form of one or more data structures, of which menu data structure 1141 is generally representative. Data structure 1141 includes a menu identifier field 1141A, a location identifier 1141B for associating the menu with a particular geographic region, an end point identifier 1141C for associating the menu with a particular endpoint or destination within the geographic region, and a time stamp identifier for indicating when the menu was last updated. Additionally, the data structure includes a menu narrative field 1141E including the text of one of more items, such as food or beverage items. Each listed item is associated with one or more category tags, such as entree, soup, salad, beverage, wheat, eggs, (other known allergens), and as well as pricing data tags. In the exemplary embodiment these allow for sorting and eliminating menu items from presentation to a given user based on stored dietary and price preferences. (Some embodiments also store the narrative menus as audio files, or in association with a preferred text-to-speech synthesizer for the restaurant or business associated with the menu.) Data sources 110 are coupled or couplable via a wireless or wireline communications network, to wayfinding server 120.

### Exemplary Wayfinding Server

Wayfinding data, examples of which were described above, can be served to blind and/or visually impaired users by various systems, an example of which will now be provided. For example, wayfinding data server 120, which provides blind wayfinding, virtual tours, intersection descriptions and menu data, among other things, to blind and visually impaired pedestrian users, includes a processor module 121, a memory module 122, a subscriber database module 123, a wayfinding service module 124, and a menu module 125.

Processor module 121 includes one or more local or distributed processors, controllers, or virtual machines. In the exemplary embodiment, processor module 121 assumes any convenient or desirable form. In some embodiments, one or more of the processors are incorporated into servers.

Memory module 122, which takes the exemplary form of one or more electronic, magnetic, or optical data-storage devices, stores machine-readable instructions that when executed by one or more processors, performs one or more of the processes and/or methods as described herein.

In the exemplary embodiment, subscriber module 123 includes one or more sets of machine-readable and/or executable instructions for collecting and storing user account or subscriber data for blind users. (Some embodiments also include sighted or non-blind users.) To this end, module includes one or more data structures, of which subscriber data structure 1231 is representative. Data structure 123 includes a unique identification portion 1231A, which is logically associated with one or more fields, such as fields 1231B, 1231C, 1231D, 1231E, and 1231F. Field 1231B includes a user account data, such as username and passwords, contact data (such as mobile telephone number and email address), and credit card billing information; field 1231C includes travel preference information, such as preferred locations (geographic regions), starting points or landmarks, and ending points or destinations. Field 1231D includes other preferences, such as dietary preferences, price preferences, user allergens, and so forth. Field 1231E includes user generated or private narrative map information, which are not generally available to other users. Field 1231F includes a vision status field, which designates the user as sighted or blind, and enables the system to filter out or leave in blind portions of narrative map data. Indeed this field can be populated with other values to provide a greater degree of granularity in filtering the available data to tailor the presentation to the particular individual's type of disability profile, e.g., cane traveler, guide dog traveler, totally blind traveler, low vision traveler, etc.

In some embodiments, wayfinding service module 124 includes one or more sets of machine-readable and/or executable instructions for receiving user requests for wayfinding data, searching databases 110, and outputting wayfinding data (narrative maps) to an access device. In particular wayfinding service module 124 includes a speech recognizer 1241, a search engine 1242, a text-to-speech converter 1243, a telephony module 1244, and a web/http interface module 1245. Speech recognizer/responder 1241 receives voice commands and requests from users, for example locations, starting points, and destinations and provides query structures to search engine 124. Search engine 124 communicates the requests to databases 112, receives the results in textual form, for example, and forward them to text-to-speech module 1243 for conversion and output to telephony module 1244 for communication with an access device having a telephone capability. Exemplary telephony capabilities include Voice-Over-Internet-Protocol (VOIP) and automated voice response systems. Web interface module 1245 provides web interface functionality and related graphical user interfaces for receives and fulfilling requests via an HTTP protocol. Text-based and graphical interfaces including web pages consisting of HTML, AJAX, Javascript, CSS over HTTP. Web interface module 1245 also supports entering and displaying narrative map data using HTML forms. Hyperlinks on web pages provide access to multimedia files for downloading, podcasts, RSS text feeds, and RSS audio feeds. Web pages also provide access to streaming of multimedia map data.

Menu module 125 includes one or more sets of machine-readable and/or executable instructions for receiving user requests for destination menu data, searching databases 110 (specifically destination menu data 114), and outputting menu data to an access device, as discussed herein, based on user preferences. Additionally, in some embodiments, menu module 125 includes instructions for playing back selected menu options, calculating purchases, and conducting secure credit card transactions based on user selected menu options.

Server 120 interacts via a wireless or wireline communications network with one or more accesses devices, such as access device 130, which can be a portable device carried by a blind or visually impaired individual.

### Exemplary Access Device

Access device 130 is generally representative of one or more access devices. In the exemplary embodiment, access device 130 takes the form of a personal computer, workstation, personal digital assistant, mobile telephone, or any other device capable of providing an effective user interface with a server or database. Specifically, access device 130 includes a processor module 131 one or more processors (or processing circuits) 131, a memory 132, a display/loudspeaker 133, a keypad or board 134, and user input devices 135, such as graphical pointer or selector 135A and microphone 135B.

Processor module 131 includes one or more processors, processing circuits, or controllers. In the exemplary embodiment, processor module 131 takes any convenient or desirable form. Coupled to processor module 131 is memory 132.

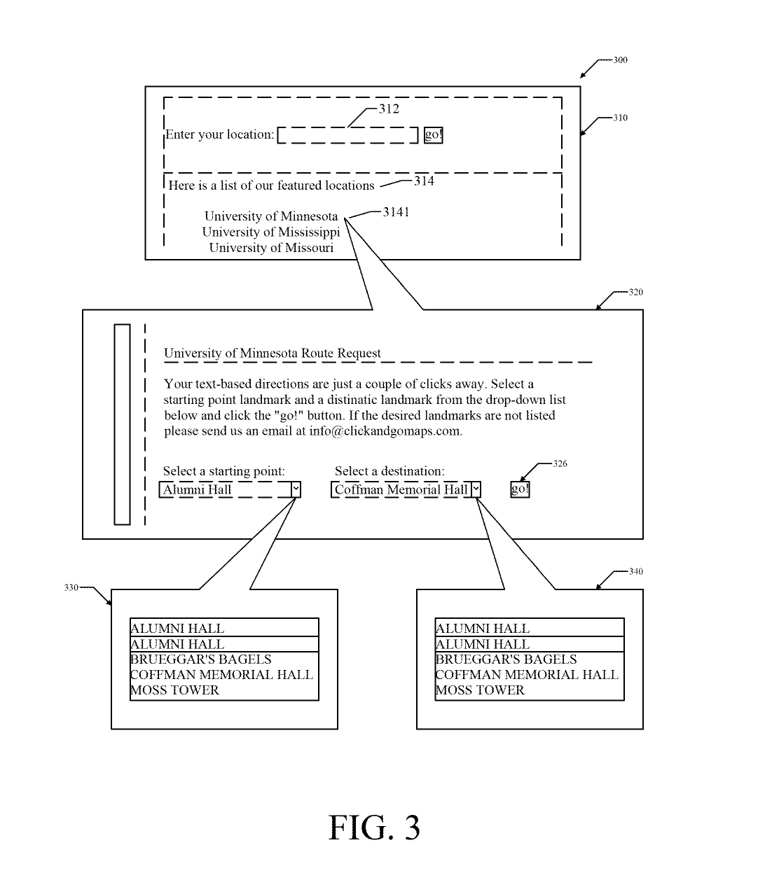

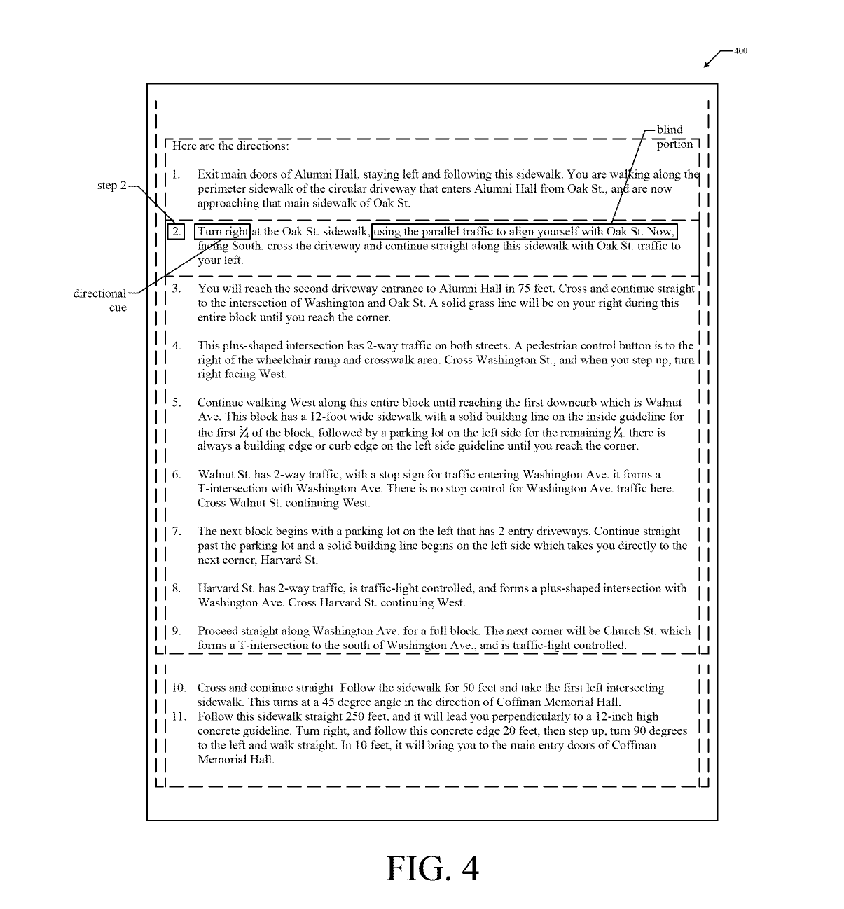

Memory 132 stores code (machine-readable or executable instructions) for an operating system 136, a browser 137, and a graphical user interface (GUI) 138. In the exemplary embodiment, operating system 136 takes the form of a version of the Microsoft Windows operating system, and browser 137 takes the form of a version of Microsoft Internet Explorer. Operating system 136 and browser 137 not only receive inputs from keyboard 134 and selector 135, but also support rendering of GUI 138 on display 133. Upon rendering, GUI 138 presents data in association with one or more interactive control features (or user-interface elements), as shown for example in FIGS. 3 and 4 and further described below. (The exemplary embodiment defines one or more portions of interface 138 using applets or other programmatic objects or structures from server 120 to implement the interfaces shown or described elsewhere in this description.)

According to embodiments described below, the access device 130 will also have one or more output capabilities associated with its hardware and/or software to output wayfinding information to a blind or visually impaired individual in a manner that is personalized to the user of that access device 130. More specifically, the wayfinding data can be transmitted from the server(s) 120 in an accessible digital format to the user's access device 130. The individual user receives that data in his or her preferred format, on their personal device 130. Thus, the delivery of the wayfinding information in, e.g., braille, audio, or text, relies upon the capabilities of that personal device 130. Thus, by design, the delivery of accessible data on the individual user's device 130 eliminates the need for users to learn a new interface. Since it is the user's personal device, that device is already configured to present data in a manner than meets that individual's needs and preferences, e.g., braille, audio, refreshable braille, large print, etc.

The access or user device 130 may, for example, have a wayfinding application (app) running thereon which processes the data received from the server(s) 120 and presents it to the user in his or her preferred format(s). Examples include I-Phone wayfinding apps or Google wayfinding apps. Such apps can also process received proximity beacon identification signals to trigger the provision of additional wayfinding information as will be described in more detail below.

### Exemplary Method(s) of Operation

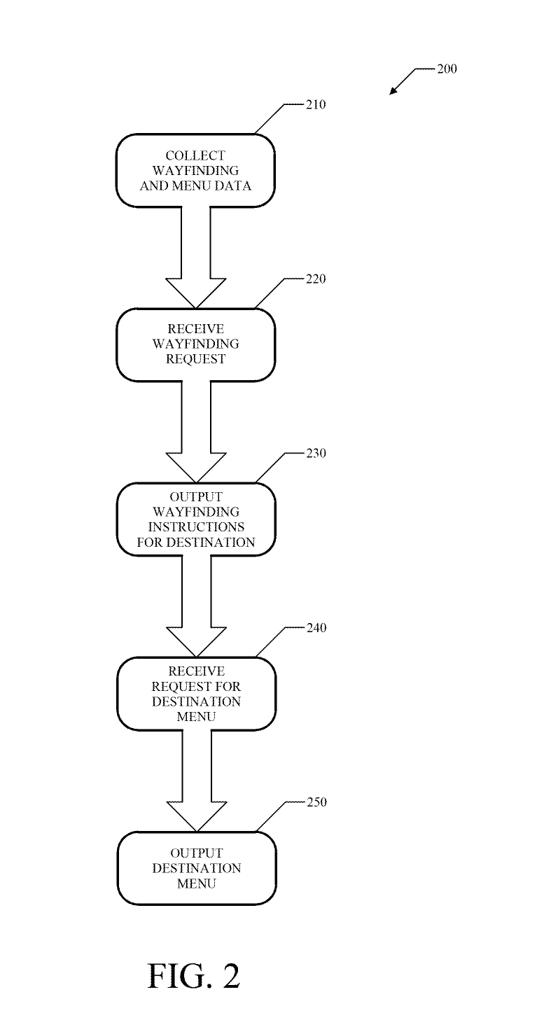

FIG. 2 shows a flow chart 200 of one or more exemplary methods of operating a system, such as system 100. Flow chart 200 includes blocks 210-299, which are arranged and described in a serial execution sequence in the exemplary embodiment. However, other embodiments execute two or more blocks in parallel using multiple processors or processor-like devices or a single processor organized as two or more virtual machines or sub processors. Other embodiments also alter the process sequence or provide different functional partitions to achieve analogous results. For example, some embodiments may alter the client-server allocation of functions, such that functions shown and described on the server side are implemented in whole or in part on the client side, and vice versa. Moreover, still other embodiments implement the blocks as two or more interconnected hardware modules with related control and data signals communicated between and through the modules. Thus, the exemplary process flow applies to software, hardware, and firmware implementations.

At block 210, the exemplary method begins with collecting and organizing narrative map and restaurant menu data. Note that these embodiments are not limited to these two types of data, which are simply examples, but can be used to disseminate any type of information which will be helpful to blind or low-vision pedestrians. Other categories of data which can be provided include: narrative route directions, point of interest (POI) descriptions, intersection descriptions, and virtual tours. In the exemplary embodiment, this entails expert collection and drafting of narrative map data for various locations. The narrative map data is uploaded as text into the database. In some embodiments, various portions of the narrative map data is tagged to facilitate use, pursuant to data structure 1121. For example, the particular map itself is tagged with starting and ending landmarks, a time stamp, author, total number of steps. Each step is also separately tagged or labeled with a sequence number. Moreover, some embodiments label or tag portions of the text within each step to indicate for example that the tagged portion is a distance quantity or that the tagged portion is a blind wayfinding instruction or description. This latter tag facilitates filtering of the narrative map for use by a sighted person. The exemplary embodiment also collects textual menu data and structures it according data structure 1141. Exemplary execution continues at block 220.

Block 220 entails receiving a wayfinding request from a blind pedestrian user. In the exemplary embodiment, this entails user making a selection from either a graphical user interface or via voice command menu, using a mobile telephone or personal digital assistant or personal computer. In the case of a graphical user interface, the exemplary embodiment uses interfaces as shown in FIG. 3. These interfaces guide a user to select or identify a location, such as city, state, university, airport, shopping mall other defined geographic region, or to initiate a search of database for relevant blind-ready walking map data. Or, alternatively user selects from a drop down menu or list of predefined or dynamically determined locations. In some embodiments, the list and menus are presented after a user login, which allows the lists and menus to be based on stored user preference information, such as a stored set of favorite or most recently used locations or regions. Additionally, some embodiments are responsive to current location information, for example, from a Global Positioning System (GPS), to determine which of a set of available lists and menu options are appropriate for presentation to a user, reducing the number of selections for a user to consider or eliminating the need for a user to make a selection at all. This screen also includes an option to view a customized low vision map of a route or virtual tour.

After selection of University of Minnesota from map region definition page (or from a listing of available projects), User selects a starting point, landmark. In some embodiments, the starting point is selected automatically based on current user position, which can be determined using positional information in the client access device associated with the user, for example, mobile telephone with WiFi or GPS positional capability. In some embodiments, this starting point, is taken automatically to be the last user selected destination. Again, it may also be selected automatically based on stored user preference information.

The user then selects a destination from the drop down menu and selects the “Go” option or icon 326 to initiate a search of database for the blind-ready map data to travel (e.g. walk) from the starting point to the destination. (Some embodiments provide wheel-chair or stair-free accessible travel directions which direct users to ramps, railings, and other walking surfaces that are designed for use by wheel-chair or other disabled travelers. Some embodiments also allow users to look for other travel features, such as restrooms, family restrooms, diaper changing stations.

In some embodiments, the selections shown here on a graphical user interface, are presented as audio to the user via telephone and voice-activated technologies. Also, some embodiments allow output of the directions in audio form for selected playback on a mobile client device, as MP3 or podcast. In some embodiments, the playback of the audio directions is synched to real-time positional information from a GPS system or to a command signal, such as a command given verbally or via a keypad or other manual entry from the user.

Block 230 entails outputting wayfinding instructions (blind ready wayfinding instructions to an access device carried or used by a blind pedestrian. In the exemplary embodiment the output is provided as audio output via a telephony interface or as textual output via a web interface. FIG. 4 shows an exemplary web interface displaying textual representation of blind-ready wayfinding instructions.

Block 240 entails receiving a request for a menu associated with a given landmark or destination. In the exemplary embodiment, the destination is by default the destination associated with the most recently fulfilled wayfinding data request. However, in other embodiments, the menu is associated with GPS coordinates and the system uses the user's current GPS or similar positional information to determine the most likely menus.

In block 250, the system outputs a destination menu to the user in audio and/or text form. In some embodiments, the menu is output based on user preferences, such as dietary and/or price preferences to reduce data transfer demands and improve useability of complex menu options. Additionally some embodiments receive voice commands to filter and sort menu options. Some embodiments also allow users to eliminate items or reserve items as maybes as they are played out. This enables the user to rapidly converge on desired selections and ultimately make decisions, and/or place orders via the system.

### Sample Narrative Maps

To better understand the types of information which can be served to blind and/or visually impaired individuals according to these embodiments, some additional, sample narrative maps are provided below.

### Route: Alumni Hall to Coffman Memorial Hall

1. Exit main doors of Alumni Hall, staying left and following this sidewalk. You are walking along the perimeter sidewalk of the circular driveway that enters Alumni Hall from Oak St., and are now approaching that main sidewalk of Oak St.

2. Turn right at the Oat St. sidewalk, using the parallel traffic to align yourself with Oak St. Now, facing South, cross the driveway and continue straight along this sidewalk with Oak St traffic to your left.

3. You will reach the second driveway entrance to Alumni Hall in 75 feet. Cross and continue straight to the intersection of Washington and Oak St. A solid grassline will be on your right during this entire block until you reach the corner.

4. This plus-shaped intersection has 2-way traffic on both streets. A pedestrian control button is to the right of the wheelchair ramp and crosswalk area. Cross Washington St., and when you step up, turn right facing West.

5. This block has a 12 foot wide sidewalk with a solid building line on the inside guideline for the first ¾ of the block, followed by a parking lot on the left side for the remaining ¼. There is always a building edge or curb edge on the left side guideline until you reach the corner.

6. Walnut St. has 2-way traffic, with a stop sign for traffic entering Washington Ave. It forms a T-intersection with Washington Ave. There is no stop control for Washington Avenue traffic here. Cross Walnut St. continuing West.

7. The next block begins with a parking lot on the left that has 2 entry driveways. Continue straight past the parking lot and a solid building line begins on the left side which takes you directly to the next corner, Harvard St.

8. Harvard St. has 2-way traffic, is traffic-light controlled, and forms a plus-shaped intersection with Washington Ave. Cross Harvard St. continuing West.

9. Proceed straight along Washington Ave for a full block. The next corner will be Church St. which forms a T-intersection to the south of Washington Av, and is traffic-light controlled.

10. Cross and continue straight. Follow the sidewalk for 50 feet and take the first left intersecting sidewalk. This turns at a 45 degree angle in the direction of Coffman Memorial Union.

11. Follow this sidewalk straight for 250 feet, and it will lead you perpendicularly to a 12-inch high concrete guideline. Turn right, and follow this concrete edge 20 feet, then step up, turn 90 degrees to the left and walk straight. In 10 feet, it will bring you to the main entry doors of Coffman Memorial Hall.

### Route: Brueggars Bagels to Alumni Hall

1. Exit the main front door of Brueggars Bagels. This exit doorway is diagonally oriented towards the intersection of Washington Ave and Oak St.

2. With your back to these doors, the corner of the intersection is 10 feet ahead. Walk in the direction of 10 o'clock, find the curb and align yourself to cross Washington Ave. You are now facing North.

3. This plus-shaped, light-controlled intersection has 2-way traffic on both streets. A pedestrian control button is to the left of the wheelchair ramp and crosswalk area. Cross Washington St., continuing North, and in 20 feet, you will find a grass-line on the left side edge. This edge continues without a break for approximately 400 feet. The first noticeable change underfoot is a slight slope down as you approach an entry driveway leading towards the Alumni Hall building.

4. Cross this 20-foot driveway and continue straight. A grass-line resumes on the left. In another 50 feet, the second section of this circular driveway appears. Cross this 20 foot driveway and turn left, now following the right side grass-line of this entry sidewalk.

5. This right-side grass line changes in 50 feet to concrete, and 50 feet after that it reaches the main entry doorway to Alumni Hall. Four sets of double doors are found at this main entrance. Enter these doors and you will be in the main lobby. Elevators are to your right, following the direction of the floor carpet, in 150 feet.

### Route: Moos Tower to Brueggars Bagels

1. Exit main front doors of Moos Tower facing Washington Ave. You are facing North. Moos Tower is located on the South side of Washington Ave, between Church St and Harvard St.

2. Carefully walk straight out of these doors, using constant contact technique (if a cane traveler). You are now approaching a long edge of perpendicular steps, about 25 feet away. Descend these stairs (one flight of 10 steps), and when you reach the lower landing, you will be on the main level of the Washington Ave sidewalk, but 30 feet from the curb.

3. Walk straight to the curb, turn right and proceed parallel to Washington Ave. You are now walking East. This part of the block has a large building on the right side which forms the last long guideline before reaching Harvard St.

4. Harvard St has 2-way traffic, is traffic light controlled, and forms a plus intersection with Washington Ave. Cross Harvard St continuing East. The next block begins with a solid building line begins on the right, and ends with a parking lot and 2 entry driveways. Continue straight to the next corner, Walnut St.

5. Walnut St. has 2-way traffic, a stop sign for traffic entering Washington Ave, and forms a T-intersection with Washington Ave. There is no stop control for Washington Avenue traffic here. Cross Walnut St. continuing East.

6. Continue East along this entire block until reaching the first downcurb which is Oak St. This block has a 12 foot wide sidewalk with a parking lot on the right side for the first ¼ distance and a solid building line on the inside guideline for the last ¾ distance of the block. There is always a building edge or curb edge on the right side guideline until you reach the corner.

7. Facing East at the corner of Oak St. and Washington Ave, Brueggars Bagels is immediately behind you and at 4 o'clock, 10 feet away. Enter through 2 sets of doors, and the main counter is at 2:00, 30 feet away.

### Enhancement of Narrative Maps Using Real Time Location Supporty and Redirection

As mentioned above, it would also be desirable to be able to redirect blind and/or visually impaired individuals who, having been provided with wayfinding instructions like the narrative maps described above, via the afore-described system, nonetheless find themselves off course between their starting point and desired ending point. Additionally, in some cases like environments which have new hazards, it would be desirable to augment the afore-described narrative maps. According to one embodiment, the recently developed i-beacon technology, or the like, can be added to provide real-time indoor location support to the blind pedestrian as an added feature to the embodiments described above with respect to FIGS. 1-4.

Briefly, i-beacons are low powered, proximity transmitters which emit unique identification signals or values using Bluetooth Low Energy (BLE) technology. A user device can run one or more applications (apps) each of which are configured to listen for one or more of the unique identification signals emitted by i-beacons and to trigger an action when a unique i-beacon ID is received that matches its search criteria. These proximity beacons are presently used by retail stores in malls to sell products to potential customers who are within range. For example, a user with an i-beacon app for his or her favorite shoe store running on his or her cellphone or tablet device, might be informed when he or she comes into range of an i-beacon for that store of a particular sale event that is available to that customer. More specific details regarding i-beacon transmissions and their potential usage in exemplary wayfinding applications according to embodiments are provided below.

Embodiments described herein leverage i-beacon technology, or the like, to assist in the direction (or redirection) of blind or visually impaired individuals, e.g., using a narrative map provided as described above to an access device 130 via system 100. As an illustrative example, consider the following narrative map

### Starting Landmark: Disability Services

### Destination Landmark: Amsterdam M-11 Bus Northbound

In this example, there are 7 directional steps to go from the starting landmark “Disability Services” to the destination landmark “Amsterdam M-11 Bus Northbound”, which could be provided to a user's access device 130 using system 100 as a narrative map with the following instructions:
1. With your back to the disability services door, walk towards 1:00 to the Thorndike exit doors 40 feet away.
2. Pass through 2 sets of automatic double doors to an outdoor driveway. A small parking lot is to the right, and a straight building edge to the left. Walk ahead, trailing the left side building wall.
3. In 150 feet, you reach the perpendicular sidewalk of 120th street. A security booth is on the left side as you reach this sidewalk.
4. Pass the security booth, and turn left in the 120th street sidewalk towards Amsterdam. In 100 feet, after passing left side concrete planters and metal benches, a downslope begins.
5. Continue in a descending sidewalk 500 feet to the corner of Amsterdam. Stay straight to cross Amsterdam.
6. This intersection is signalized, with 6 lanes of 2-way traffic. After crossing, turn left.
7. Walk ahead in a descending sidewalk. The Northbound M11 bus stop is 70 feet ahead along the left side curb.

While the foregoing narrative map will be very useful to a blind or low vision person in navigating between the starting landmark and the destination landmark, it can be enhanced by providing additional feedback through the use of proximity beacons, such as i-beacons. For example, consider the modified version of the afore-described narrative map with, additional feedback in parentheses, as follows:
1. With your back to the disability services door, walk towards 1:00 to the Thorndike exit doors 40 feet away. (as a traveler gets within 20 feet of doors, the user's access device 130 receives a unique code which is transmitted by a proximity beacon placed near the exit doors which unique code triggers an app running on the device 130 to deliver a message to the headset of the traveler announcing that the Thorndike doors are ahead)
2. Pass through 2 sets of automatic double doors to an outdoor driveway. A small parking lot is to the right, and a straight building edge to the left. Walk ahead, trailing the left side building wall.
3. In 150 feet, you reach the perpendicular sidewalk of 120th street. A security booth is on the left side as you reach this sidewalk. (as a traveler gets within 20 feet of security booth, the user's access device 130 receives a unique code which is transmitted by a proximity beacon placed near the security booth, which unique code triggers an app running on the device 130 to deliver a message announcing that the security booth is ahead)
4. Pass the security booth, and turn left in the 120th street sidewalk towards Amsterdam. In 100 feet, after passing left side concrete planters and metal benches, a downslope begins.
5. Continue in a descending sidewalk 500 feet to the corner of Amsterdam. Stay straight to cross Amsterdam.
6. This intersection is signalized, with 6 lanes of 2-way traffic. After crossing, turn left.
7. Walk ahead in a descending sidewalk. The Northbound M11 bus stop is 70 feet ahead along the left side curb. (as a traveler gets within 20 feet of the M-11 bus stop, the user's access device 130 receives a unique code which is transmitted by a proximity beacon placed near the exit doors which unique code triggers an app running on the device 130 to deliver a message announcing that the bus stop is ahead)

Regarding step #7 above, note that blind pedestrians have always found it difficult to pinpoint the exact location of certain types of desired destinations, such as bus stops on long city blocks. With a beacon installed and configured with a 20 foot messaging range, any blind pedestrian coming from either direction would be informed that they were within 20 feet of that bus stop, and so could then veer towards the curb edge and continue until they located the shelter or post. This avoids the unadvisable alternative wherein the blind traveler walks the entire block along the curb edge (i.e, there is greater difficulty because of the presence of more obstacles, and also heightened dangers in being closer to the street and moving traffic, etc.). So the use of a proximity beacon at a bus stop as described above facilitates safety and efficiency in travel, and gives the pedestrian a new and highly valuable real-time location support, which has never been available previously.

Moreover, i-beacons (or the like) as used in these embodiments can also trigger the real-time delivery of a “low vision customized map”, by an application running on the user's access device 130, which could then be used by the smartphone, iPad, or iPod of the blind or vision impaired traveler. In this latter example, such a real-time delivery of a low vision customized map might be more helpful in locating elements such as an indoor office, ticketing window, restroom, etc. More generally, i-beacons or the like can be used in embodiments described herein to serve one or more of the following purposes: 1) to alert or announce the presence of ongoing environmental hazards; 2) for emergency announcements or instructions; 3) for landmark identification support; and 4) for real-time location-specific orientation support.

From the foregoing, it will be apparent that embodiments contemplate the provision of additional feedback to a narrative map for a blind or low vision person who is using the map as a wayfinding tool. Such real time, location based feedback can, as described above, be provided using the recently introduced i-beacon technology, but is not limited thereto. Indeed any available mechanism which provides proximity information relative to landmarks associated with the narrative map that can be accessed by the access device 130 can be used to provide such feedback to the blind or low vision user.

For example, it is also possible to use existing WiFi access points to provide location information to the access device 130, which the access device 130 (or an app running thereon) can use to determine whether the blind or low vision person carrying the access device is at a location where she or he should be provided with additional feedback regarding their current whereabouts. An example of such technology is provided in U.S. Pat. No. 8,700,060 for “Determining a location of a mobile device using a location database”, the disclosure of which is incorporated here by reference. The method described in the '060 patent employs location estimation through the successful communication with one or multiple Wi-Fi access points, which can be used in the same manner as described above by a user access device 130 to determine its current location and decide whether to provide the user with additional feedback (e.g., audio feedback) regarding his or her progression along the narrative map. Thus the term “proximity beacon” is used herein to describe a class of devices or techniques, including but not limited to i-beacons, which provide a user device with a triggering message or data that results in an application on the user device to output additional wayfinding information.

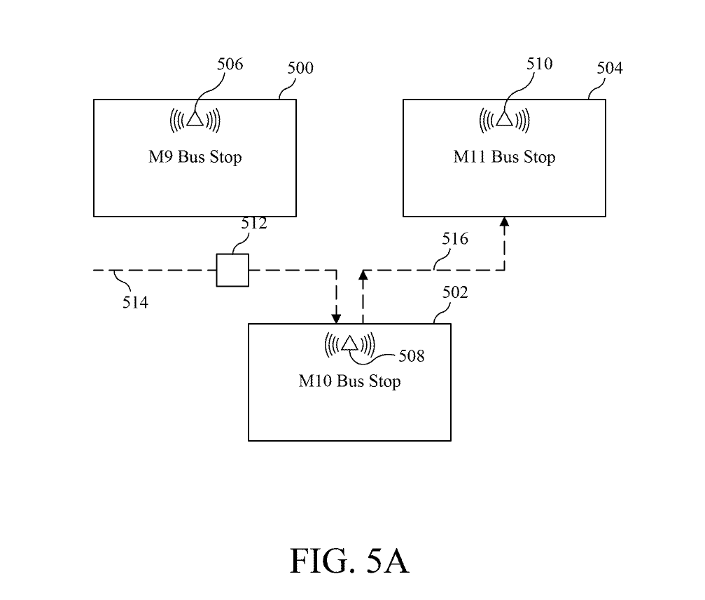

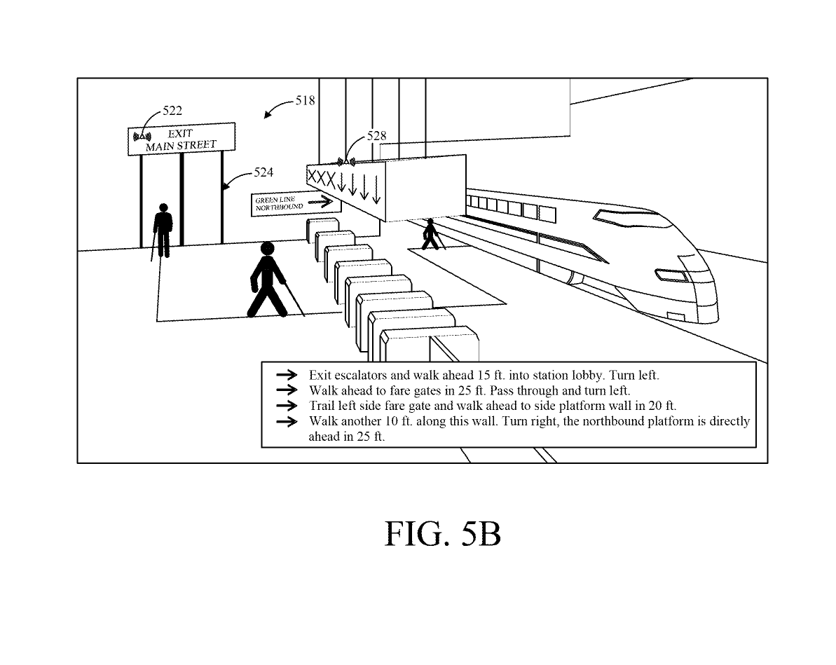

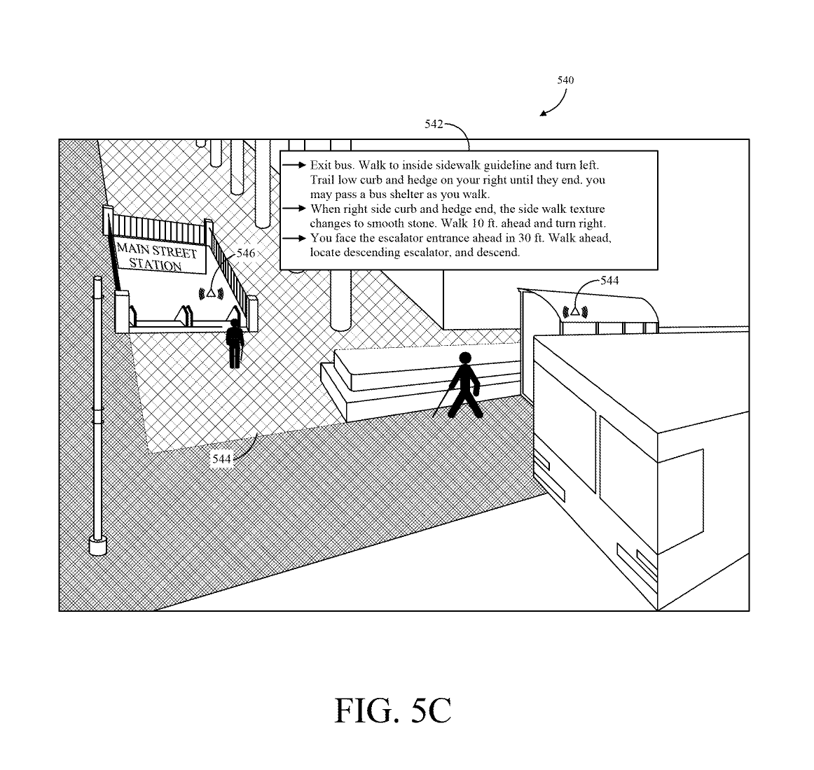

As seen in the foregoing example, proximity beacons or the like can be used to provide real-time, location-based information to enhance a narrative map by providing redundancy and intermediate confirmations that a blind or low vision person is correctly following the narrative map. However, according to embodiments, such techniques can likewise be provided to generate redirection feedback via access device 130 if the user has strayed from his or her desired path. For example, suppose that, in the previous example, there were several bus stops proximate one another in a group where various buses stopped to pick up and let off passengers, e.g., an M9, M10 and M11 bus stop in a close grouping as illustrated in the top view of FIG. 5(a).

Consider further that each bus stop, represented by a wind/rain shelter 500, 502 and 504, is also equipped with a respective proximity beacon 506, 508, and 510 (or other transmitting device) from which access device 130 can localize (or be informed of) its position to within some small radius. Then, if the user's access device 512 travelling along path 514 stops at the wrong bus stop 502 for the M10 bus, e.g., due to confusion attributable to the user overhearing another person say (wrongly) that this was the M11 bus stop, then the user's access device could detect the beacon signal from beacon 508 and differentiate it from the expected signal generated by beacon 510. In response to the detection that the user had stopped (e.g., after a predetermined time period) proximate the wrong beacon 508, the user's access device could inform the user to redirect toward bus stop 504. For example, user's access device 512 could output an audible instruction such as “you are at the m10 bus stop. Exit the current bus stop and turn right, proceed 20 yards, turn left into the M11 bus stop and listen for a confirmation tone that you are at the M11 bus stop” to encourage the user to follow the redirection path 516 shown in FIG. 5(a). As will be appreciated by those skilled in the art, this is merely one example of how location based technology can also be used to redirect a blind or low vision user relative to a previously provided narrative map.

In the above example, bus stop “A” will have some tactile or other cue that distinguishes it from the adjacent bus stops “B and C”. And so, receipt by the user's access device of the beacon signal for bus A would result in the system delivering a short narrative to that user's device highlighting those differences and directing the pedestrian to the correct bus stop, with information that allows the traveler to confirm that they are indeed at bus stop A. In addition, a low vision map could be generated.

Another embodiment is illustrated in FIG. 5(b) for an underground subway environment 518. Therein, the text in block 520 represents navigation information that can be provided to the blind or vision impaired user at various times, e.g., before he or she leave his or her house to go to the subway in order to enable them to prepare, just before he or she enters the subway and/or while they are navigating their way through the subway environment 518. This information can be presented in any of a number of ways that can be chosen by the blind or vision impaired individual, e.g., pre-organized text and MP3 download, braille, large print, mobile website and/or a smart phone application. Additionally, an interactive voice response phone system can be used to provide on-the-fly directions as they are traversing the environment 518.

As mentioned above, however, the embodiment of FIG. 5(b) also provides for proximity beacons which enhance the navigation experience for the blind or low vision individuals that use the system. For example, a first proximity beacon 522 could be placed proximate the escalators 524 to inform the user of their location relative to the fare gates 526, e.g., by audibly or otherwise informing the user (through their user's access device 130) that “after passing through the fare gates, the ascending escalator is 20 feet ahead along the right wall.” As another example, a second proximity beacon 528 could be placed near the fare gates 526 and provide the blind or low vision user with additional navigational guidance. For example, when the user walks toward the fare gates 526, and his or her user access device 130 receives the unique ID code emitted by the proximity beacon 528, the user access device 130 could output to the user information such as “directly ahead, in 20 feet, after passing through the fare gates, is the platform (edge) for the northbound Green Line train.”

From the foregoing, it will be appreciated that by using the proximity beacons 522 and 524, a blind or low vision user can receive timely updates about their whereabouts within the subway environment 518 which reinforce the baseline directions 520 which they may have earlier reviewed on their user access device 130. This enables the user to confirm that they are on their desired path regardless of how quickly or slowly they are travelling through the subway station, or alternatively, if they receive navigational guidance from a proximity beacon which informs them that they are heading the wrong way, e.g., “you are now approaching the Red Line platform”, to reorient themselves in the desired direction.

Another example is provided in the embodiment of FIG. 5(c). Therein, an aboveground navigation environment 540 associated with a bus stop proximate a subway entrance is depicted. As in the previous embodiment, a blind or low vision user of the system is provided with baseline navigation information 542 which helps that person to navigate along a path 544 from the bus, to the subway entrance. This baseline information 542 is made available to the user via his or her user access device 130, e.g., in the manner described above, at any desired time, e.g., before he or she gets on the bus, while on the bus and/or just after exiting the bus enroute to the subway entrance.

Once again, proximity beacons can be added to the system to provide real-time orientation to support as the navigation progresses. For example, upon approaching the bus stop, the user's access device 130 can receive a unique code from proximity beacon 544 which informs him or her that the bus stop is 20 feet ahead on the inside of the sidewalk. Similarly, while moving from the bus to the subway entrance along path 544 which was indicated by the baseline directions 542, the user can be informed by receipt of a code from proximity beacon that the subway station entrance is located 20 feet ahead and has an escalator (or stairs).

From the foregoing, it will be appreciated that the baseline navigation data 520, 542 in the previous embodiments can be acquired by the user's access device 130 at any time and presented to the user as an output from the user's access device at any time. Indeed many blind or low vision users may prefer to acquire and review this navigation information in advance to feel more comfortable with their travel plans. By way of contrast, the real-time, location based navigational information which is generated by approaching within a predetermined distance from a proximity beacon will typically only be presented to the user at that time. However it may be desirable for the user's access device 130 to download and store the additional navigation information which will be output upon proximity to a proximity beacon, so that it is readily available if the user is in a location where communication access with the system, e.g., underground in subway areas which are not well-served by WiFi hotspots, is limited.

From the foregoing it will be apparent that proximity beacons such as i-beacons can be used to enhance wayfinding systems and techniques, such as those described in the '935 patent by, for example, alerting blind or low vision system users to the presence of hazards. Some hazards are a natural part of the built environment (e.g., a platform edge in a subway station), while other hazards are temporary, e.g., related to construction or emergency situations. According to an embodiment, the former type of hazard can be addressed in two ways. First dedicated i-beacons can be used only to alert or announce the presence of constant environmental hazard announcements. Second, the customized wayfinding narratives which are delivered to the user's personal device are adapted to emphasize the presence of these hazards while offering the safest possible route through this part of the venue.

Considering next the category of temporary hazards, e.g., construction or emergency situations, for these types of hazards it is assumed that when a facility has, for example, an elevator or escalator out of service, or is in the process of internal station renovation that impacts navigation, they are aware of this in advance and make such information known to the public via their website or other mechanism. Upon being informed by the facility of such changes which impact routes which can be taken by people using the facility, system implementers according to these embodiments address such issues by preparing temporary customized walking narratives that can be transmitted to/downloaded into a user's access device and used for the duration of the construction period to provide wayfinding navigation assistance. Additionally, special or dedicated beacons can be provided along the route that would only be used for delivering emergency route information to a blind or low vision user when they are proximate these types of hazards.

For example, a significant construction project would typically warrant the use of such a dedicated beacon at the entrances of the station. By doing so, a disabled traveler would not need to travel to the center of the station to then find, for example, that a platform is inaccessible because of construction. The beacon message, at the entrance, would concisely explain the emergency.

According to some embodiments described herein the i-beacons or proximity beacons are used for landmark identification, hazard and construction announcements, and for location specific orientation support but are not used for providing navigation directions per se. Since the proximity beacons transit messages omnidirectionally, e.g., radially, directions transmitted by such beacons cannot be simultaneously correct for travelers who coming toward the beacon from different directions.

According to another embodiment, however, this limitation associated with proximity beacons that transmit omnidirectionally can be overcome. Presently, many new venues are installing such proximity beacons, and it is anticipated that travelers are going to be bombarded with non-stop audio announcements as they walk through airports, train stations, malls, etc., which are triggered by receipt of messages from numerous beacons located together close proximity. Most of these proximity beacons will identify landmarks that are not relevant to travelers' individual destinations. While some people may find it may be helpful to know that they have just passed, for example, a Barnes and Noble or a Burger King in an airport, most other travelers will prefer to get to their destination (e.g., a connection to a flight, bus or train) with the utmost efficiency, and may be annoyed or distracted by these numerous messages. According to an embodiment, a more sophisticated i-beacon messaging system can be implemented that only triggers those specific landmarking messages that are relevant to the route selected on the wayfinding application running on a blind or low vision person's personal user device.

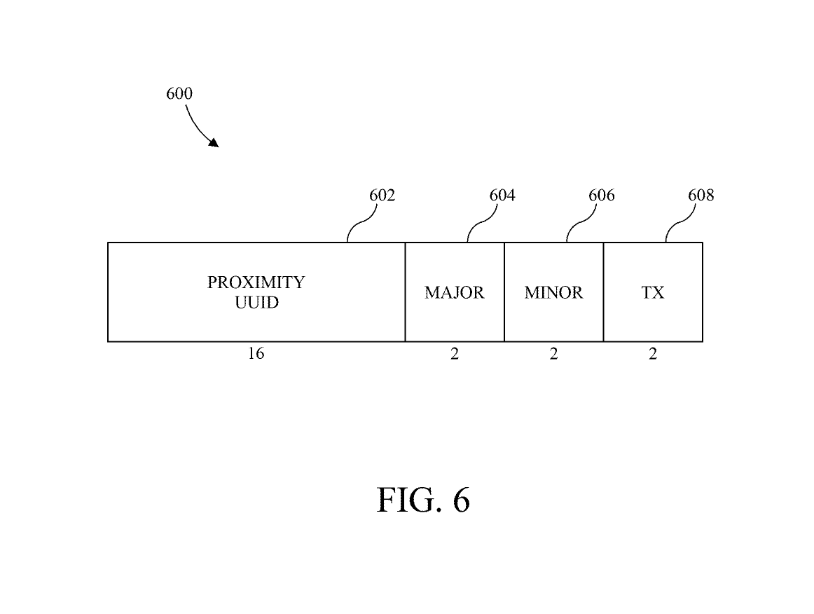

For example, and using i-beacons as an example of the more general proximity beacon concept described herein, consider the four data fields 600 which are broadcast by an i-beacon operating in advertisement mode as shown in FIG. 6. Note that the illustrated fields are encapsulated in a higher level BLE packet (encapsulation not shown in FIG. 6). First, as seen in FIG. 6, there is a proximity UUID 602 field which is a 16 byte string that can be used to differentiate a large group of related beacons. For example, all of the i-beacons which are used in a particular wayfinding system according to these embodiments can be assigned a unique value to the UUID field 602 which enables the wayfinding application operating on a user device to distinguish wayfinding proximity beacons from all of the other beacons which are operating in the same geographical area, e.g., to identify other businesses such as Burger King's beacons or Barnes and Noble's beacons.

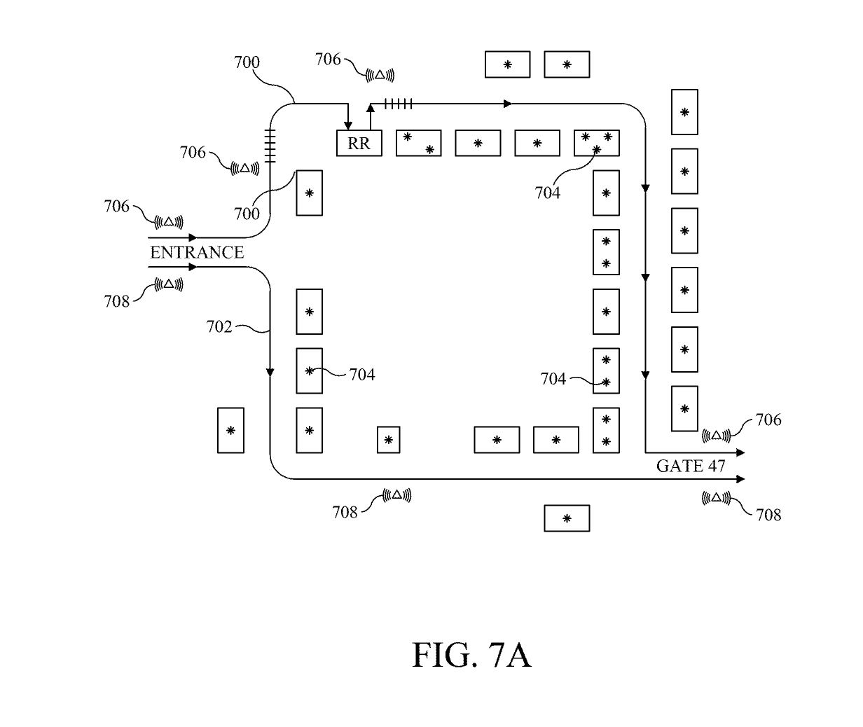

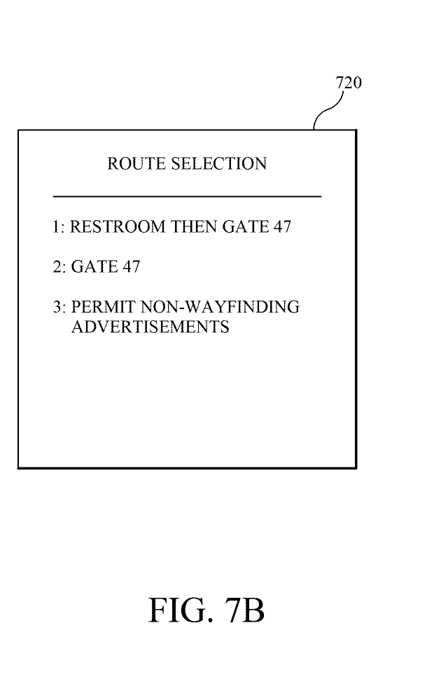

Moving from left to right, the next data field found in an i-beacon's advertisement payload is called the major field 604: This is a 2 byte string used to distinguish a smaller subset of beacons within the larger group identified by the UUID field 602. For example, in the context of wayfinding embodiments, if a UUID field 602 identified all of the beacons in a particular area which are associated with a wayfinding system, e.g., in an airport or a subway system, then the major field 604 could contain a value which identifies a subset of those beacons. For example each subset of beacons which are identified with different major values in field 604 could be used in different routes provided by the wayfinding system in the same geographic area. These, and other, i-beacon usage techniques for wayfinding will be further discussed below with respect to the example of FIGS. 7(a) and 7(b).

Continuing on. the next data field is the minor field 606. This is a 2 byte string which can be used to identify individual beacons. For example, if an i-beacon is placed on a kiosk in an airport (or any other important landmark, e.g., a bus stop or subway payment gate), that i-beacon will have a unique minor field 606 value (at least relative to the other i-beacons which have the same UUID 602 value and/or major 604. When the wayfinding application running on the user device receives the signal from this particular i-beacon and matches its minor value 606 with the identical value which it has stored therein for the i-beacon which was placed on the kiosk, then the application will know that the user is within a certain radial distance of the kiosk, e.g., the reception range of the signal which could be 20-100 meters for example. This information can be used by the application in various ways, including to simply inform the blind or low vision user that she or he is nearing the landmark.

The last field shown in the payload of an i-beacon advertisement packet is the Tx Power 608: This field can be used by the application running on the user device to determine proximity (distance) from the i-beacon which transmitted the packet containing field 608. More specifically, the TX power value provided in field 608 is defined as the strength of the i-beacon signal at a distance of 1 meter from the i-beacon, which value is calibrated and hardcoded in advance. Devices, e.g., the user device with its application or the server which provides the navigation narratives (or both), can then use this value as a baseline to generate a distance estimate which is somewhat more precise than simply knowing which i-beacon generated the signal using the minor field 606.

With a system in accordance with the foregoing embodiment in place, the blind or low vision user will have the option to permit only beacon messages that are critical to the route selected on the application to be output from his or her user access device. This will eliminate the non-stop series of announcements of unimportant landmarks. For those travelers who are in no rush, and want to know everything that is around them, that option will remain open to them. The examples of FIGS. 7(a) and 7(b) will help to illustrate these features.

Starting with FIG. 7(a), a layout of two routes through part of an airport is illustrated. A first route 700 takes a blind or low vision traveler from an entrance, first to a rest room, and then on to his or her Gate 47 for departure. A second route 702 takes the blind or low vision traveler on a more direct route to Gate 47. Along both routes 700 and 702 a number of stores, information booths, concession stands, and the like are present and are represented by rectangles having one or more of their own i-beacons represented by asterisks. These i-beacons can trigger output of advertisements or announcements associated with the vendors' goods or services on a traveler's user device when they within reception range. Also illustrated in FIG. 7(a) are some i-beacons associated with the provision of navigation information to a blind or low vision traveler as they traverse either route 700 or 702. More specifically, a first set of i-beacons 706 are provided along route 700, and a second set of i-beacons 708 are provided along route 702.

Both sets of i-beacons 706 and 708 can be provided with the same UUID field 602 values for transmission via a periodic BLE signal, thereby indicating that those beacons are part of the navigation system whereas the other beacons 704 will have different UUID field 602 values. Additionally, the first set of i-beacons 704 can have a different major field 604 value than the second set of i-beacons 706. This enables the navigation application running on the blind or low vision user's access device to distinguish between the proximity signals received from the various beacons and to selectively output information to the user.

For example, suppose that the blind or low vision user reaches the airport and wants to use the rest room prior to going on to his or her gate 47 without being bothered by other ancillary advertisements. In this case, the user could select that route option on his or her user device 720 from among various options. The options presented may have been pre-downloaded to his or her device before arrival at the airport, or could be generated in real time. If this selection is made, then the application operating on the user's access device will ignore or filter out received transmissions from beacons 704 and 708, while generating navigational output when it receives signals from beacons 706 by evaluating the values of the fields, e.g., the UUID and major fields 602, 604.

Conversely, if the blind or low vision user wants to go to Gate 47 by the most direct route, she or he could select option 2 from the user interface 720. In this case, the application on his or her access device will instead respond to proximity signals from beacons 708, but not beacons 706 or 704. An option can also be provided to permit non-wayfinding advertisements to be output via the user access device, e.g., when within range of one of the beacons 704, in addition to the selected wayfinding route beacons for user's that desire this additional information and/or are not in a rush to reach their ultimate destination.

It will be appreciated by those skilled in the art that the foregoing example is purely illustrative and that other embodiments contemplate other ways of using proximity beacon technology to enhance wayfinding systems for blind or low vision travelers.

### CONCLUSION

The embodiments described above are intended only to illustrate and teach one or more ways of practicing or implementing the present invention, not to restrict its breadth or scope. The actual scope of the invention, which embraces all ways of practicing or implementing the teachings of the invention, is defined only by the following claims and their

What is claimed is:

1. A method for aiding a blind or low vision traveler to navigate through a predetermined area, the method comprising:
providing, from a user access device carried by the blind or low vision traveler, a set of baseline navigation instructions for traversing the predetermined area; and
outputting, from the user access device carried by the blind or low vision traveler, additional navigational guidance information when the blind or low vision traveler is close enough to a proximity beacon to receive its signal.

2. The method of claim 1, further comprising:
receiving the baseline navigation instructions and the additional navigation information from a server to the user access device upon request from the blind or low vision traveler;
outputting the baseline navigation instructions from the user access device upon request from the blind or low vision traveler; and
outputting the additional navigational guidance information from the user access device only when the user access device is close enough to the proximity beacon to receive its signal.

3. The method of claim 1, further comprising:
receiving the baseline navigation instructions and the additional navigation information from a server to the user access device upon request from the blind or low vision traveler; and
outputting either the baseline navigation instructions or the additional navigational guidance information from the user access device upon request from the blind or low vision traveler to enable the blind or low vision traveler to preview all of the available information prior to traversing the predetermined area.

4. The method of claim 1, wherein the additional navigational guidance information is one or more of: (a) information which alerts the blind or low vision traveler to a presence of an environmental hazard, (b) information which provides an emergency announcement, (c) information which supports identification of a landmark in the predetermined area, and/or (d) information which provides real-time location-specific orientation support.

5. The method of claim 1, wherein there are a plurality of routes associated with the predetermined area, each of the plurality of routes having a corresponding set of baseline navigation instructions and one or more proximity beacons disposed along the corresponding route.

6. The method of claim 5, further comprising:
selecting, by the blind or low vision traveler, one of the plurality of routes;
receiving, at the user access device, one or more identification codes associated with one or more proximity beacons which are disposed along the selected route, wherein some of the identification codes are associated with a wayfinding system which provides the set of baseline navigation information and some of the identification codes are not associated with the wayfinding system; and
outputting the additional navigational guidance information when the user access device receives an identification code that is associated with the wayfinding system I, while ignoring other identification codes transmitted by other proximity beacons which are not associated with the wayfinding system.

7. The method of claim 6, wherein the identification codes include a first group field, a second subgroup field, a third individual beacon identifier field and a fourth transmit power field.

8. The method of claim 7, further comprising:
filtering signals from proximity beacons using the values in the first group field and second subgroup field to determine whether to output information from the user access device in response to receipt of an advertisement signal from a proximity beacon.

9. A user device for assisting a blind or low vision user to navigate a predetermined area comprising:
a processor configured to execute a blind or low vision navigation application which outputs a set of baseline navigation instructions for traversing the predetermined area; and
a receiver configured to receive a signal from a proximity beacon disposed in the predetermined area and to output additional navigational guidance information when the blind or low vision traveler is close enough to the proximity beacon to receive its signal.

10. The user device of claim 9, wherein the user device is further configured to receive the baseline navigation instructions and the additional navigation information from a server upon receiving an input from the blind or low vision traveler, to output the baseline navigation instructions from the user access device upon receiving another input from the blind or low vision traveler; and to output the additional navigational guidance information from the user access device only when the user access device is close enough to the proximity beacon to receive its signal.

11. The user device of claim 9, wherein the user device is further configured to receive the baseline navigation instructions and the additional navigation information from a server to the user access device upon an input from the blind or low vision traveler, and to output either the baseline navigation instructions or the additional navigational guidance information from the user access device upon another input from the blind or low vision traveler to enable the blind or low vision traveler to preview all of the available information prior to traversing the predetermined area.

12. The user device of claim 9, wherein the additional navigational guidance information is one or more of: (a) information which alerts the blind or low vision traveler to a presence of an environmental hazard, (b) information which provides an emergency announcement, (c) information which supports identification of a landmark in the predetermined area, and/or (d) information which provides real-time location-specific orientation support.

13. The user device of claim 9, wherein there are a plurality of routes associated with the predetermined area, each of the plurality of routes having a corresponding set of baseline navigation instructions and one or more proximity beacons disposed along the corresponding route.

14. The user device of claim 13, further comprising:
an input interface in the user device which is configure to receive a selection input from the blind or low vision traveler of one of the plurality of routes;
wherein the receiver is further configured to receive a signal including one or more identification codes associated with one or more proximity beacons which are disposed along the selected route, wherein some of the identification codes are associated with a wayfinding system which provides the set of baseline navigation information and some of the identification codes are not associated with the wayfinding system; and
wherein the processor is further configured to output the additional navigational guidance information when the user access device receives an identification code that is associated with the wayfinding system, while ignoring other identification codes transmitted by other proximity beacons which are not associated with the wayfinding system.

15. The user device of claim 14, wherein the identification codes include a first group field, a second subgroup field, a third individual beacon identifier field and a fourth transmit power field.

16. The user device of claim 15, wherein the processor is further configured to filter signals from proximity beacons using the values in the first group field and second subgroup field to determine whether to output information from the user access device in response to receipt of an advertisement signal from a proximity beacon.

17. A wayfinding system comprising:
a server configured to deliver navigational information associated with a route to a plurality of user devices;
wherein the plurality of user devices are configured to receive the navigational information and to output the navigational information to blind or low vision users in their preferred output format;
a plurality of proximity beacons disposed along said route and configured to periodically transmit advertisement messages including at least one identification code which identifies them as part of the wayfinding system.

18. The wayfinding system of claim 17, wherein the plurality of user devices are further configured to output additional navigational information associated with the route upon receipt of an advertisement message from one of the plurality of proximity beacons having said at least one identification code.

19. The wayfinding system of claim 18, wherein the additional navigational guidance information is one or more of: (a) information which alerts the blind or low vision traveler to a presence of an environmental hazard, (b) information which provides an emergency announcement, (c) information which supports identification of a landmark in the predetermined area, and/or (d) information which provides real-time location-specific orientation support.

20. The wayfinding system of claim 17, wherein one or more of the plurality of user devices can selectively be configured to ignore advertisement messages from proximity beacons which do not contain the at least one identification code.
